(19) United States
(12) Patent Application Publication
(10) Pub. No.: US 2017/0188692 A1
(43) Pub. Date: Jul. 6, 2017

(54) Adjustable Paintbrush

(71) Applicant: Dana Doorey, Pinehurst, NC (US)

(72) Inventor: Dana Doorey, Pinehurst, NC (US)

(21) Appl. No.: 15/350,826

(22) Filed: Nov. 14, 2016

Related U.S. Application Data
(60) Provisional application No. 62/273,344, filed on Dec. 30, 2015.

(51) Int. Cl. A46B 9/10; B25G 1/10; A46B 9/02

(52) U.S. Cl. CPC A46B 9/10; A46B 9/02; B25G 1/102

(57) ABSTRACT

An adjustable paintbrush that reaches tight and small substrate surfaces includes a handle, a ferrule, a plurality of bristles, and a tension locking mechanism. The plurality of bristles is connected within an opening of the ferrule and extended away from the ferrule. The handle is oppositely positioned of the plurality of bristles and rotatably connected with the ferrule by the tension locking mechanism. The adjustable paintbrush allows a painter to grip the handle in straight configuration, similar to conventional paintbrushes, while allowing the ferrule to adjusted and locked in place according to the structural formation of the substrate surface through the tension locking mechanism.

The current application claims a priority to the U.S. Provisional Patent application Ser. No. 62/273,344 filed on Dec. 30, 2015.

### FIELD OF THE INVENTION

The present invention relates generally to a paintbrush. More specifically, the present invention is an adjustable paintbrush that can angularly pivot about a locking mechanism of the adjustable paintbrush as the locking mechanism rotatably connects a handle and a ferrule of the adjustable paintbrush.

### BACKGROUND OF THE INVENTION

Paintbrushes are utilized to apply paint or ink onto the substrate surface. More specifically, a handle of the paintbrush allows the user to hold and maneuver the paintbrush. Bristles of the paintbrush that are retained by a fixed ferrule of the paintbrush transfer paint onto the substrate surface. However, traditional paintbrushes can have difficulties accessing tight spaces and small surface areas during the painting process. Such spaces include, but are not limited to, underneath or inside of cabinets or cubbies, wall surface adjacent to toilets and fixtures, and trim surfaces. Even though the paintbrushes have different width of heads to accommodate different painting surface, the fixed ferrule can limit the maneuverability of the paintbrushes. As a result, painters have to utilized various tools to reach the desired area and may have to difficulty time painting the desired area.

It is there for an object of the present invention to provide an improved paintbrush that can access tight and small spaces. More specifically, the present invention comprises a rotatable ferrule within the paintbrush so that the painter is able to access small and tight areas. The rotatable ferrule locks in place with the handle by a locking mechanism as it allows the painter to create any desired angle between the handle and the bristles. As a result, the painter is able to adjust the painting angle of the rotatable ferrule through the locking mechanism thus allowing access to small and tight areas. Additionally, the painter is able to comfortably hold the handle, similar to traditional paintbrush and straight orientation, while the rotatable ferrule can be angularly adjusted according to the small and tight areas.

### BRIEF DESCRIPTION OF THE DRAWINGS

FIG. 1 is a top perspective view of the present invention.

FIG. 2 is a front view of the present invention, showing the tension locking mechanism within the handle and the ferrule.

FIG. 3 is a bottom perspective view of the handle of the present invention.

FIG. 4 is a bottom perspective view of the ferrule of the present invention.

FIG. 5 is a front view of the ferrule of the present invention, showing the lateral surface, the first and second internal gear ring within the sleeve opening.

FIG. 6 is a front view of the tension locking mechanism of the present invention.

FIG. 7 is an exploded perspective view of the present invention.

### DETAIL DESCRIPTIONS OF THE INVENTION

All illustrations of the drawings are for the purpose of describing selected versions of the present invention and are not intended to limit the scope of the present invention.

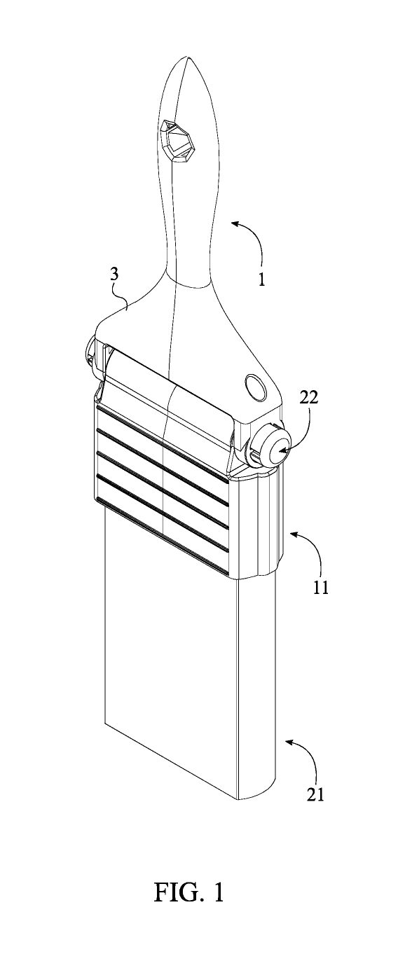

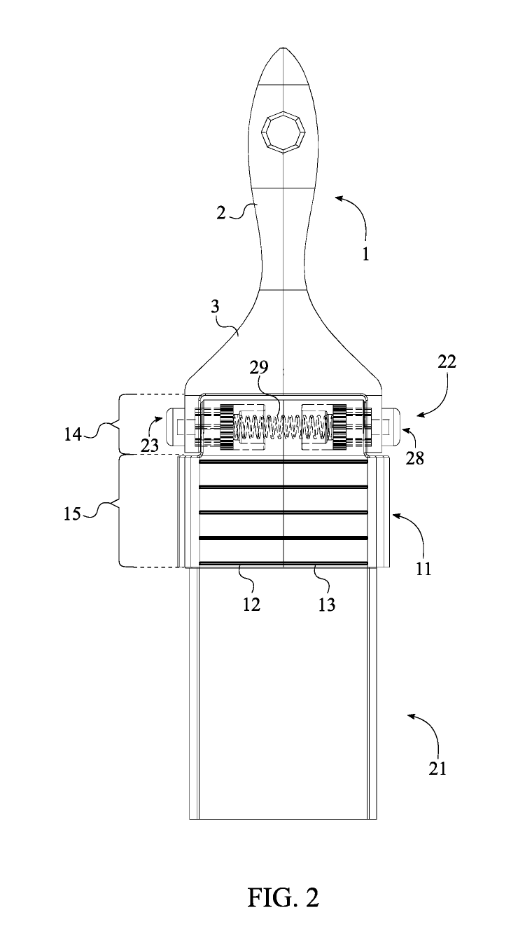

The present invention is an adjustable paintbrush that reaches tight and small substrate surfaces so that a painter can easily access these respective surfaces. Since the conventional paintbrushes can be difficult to maneuver within tight and small substrate surfaces, the present invention provides a solution to the tight and small substrate surfaces through an angularly rotatable ferrule. As shown in FIG. 1-2, the present invention comprises a handle 1, a ferrule 11, a plurality of bristles 21, and a tension locking mechanism 22. In reference to the general configuration of the present invention, the plurality of bristles 21 is connected to a bristle opening 20 of the ferrule 11 as the plurality of bristles 21 is extended away from the bristle opening 20. A head section 3 of the handle 1 is concentrically positioned with a sleeve opening 16 of the ferrule 11 and positioned opposite of the plurality of the plurality of bristles 21. Thus, the head section 3 is rotatably connected with the sleeve opening 16 through the tension locking mechanism 22. The tension locking mechanism 22 allows the painter to angularly rotate and lock the ferrule 11 with respect to the handle 1 so that the painter can selectively adjust and lock the angle of the ferrule 11 with respect to the substrate surface. More specifically, the present invention allows the painter to grip the handle 1 in straight configuration, similar to conventional paintbrushes, while allowing the ferrule 11 to be adjusted and locked in place according to the structural formation of the substrate surface.

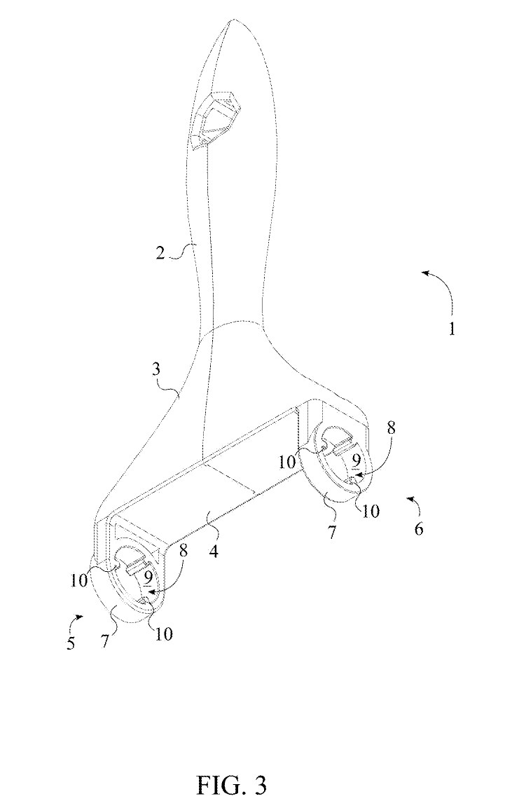

The handle 1 provides the surface area to grip the present invention and ergonomic shaped as an elongated member within the present invention. In reference to FIG. 3, the handle 1 further comprises a contoured grip section 2 in addition to the head section 3. More specifically, the contoured grip section 2 is adjacently positioned with the head section 3 along the elongated member. The contoured grip section 2 is formed into the ergonomic shape so that the painter can comfortably grip the present invention. A width of the head section 3 is approximately similar to a width of the ferrule 11 so that the ferrule 11 can rotatably connect with the handle 1 without any obstructions. In the preferred embodiment of the present invention, the handle 1 comprises a first handle half and a second handle half in order to simplify the assembly of the present invention. However, the handle 1 of the present invention can be formed into a single body as long as the handle 1 is able to rotatably connect with the ferrule 11.

In reference to FIG. 3, the head section 3 comprises a first tab 5 and a second tab 6 thus allowing the tension locking mechanism 22 to rotatably connect the ferrule 11. More specifically, the first tab 5 and the second tab 6 are oppositely positioned of the contoured grip section 2 and terminally positioned of each other across a bottom surface 4 of the head section 3. The first tab 5 and the second tab 6 are perpendicularly connected with the bottom surface 4 of the head section 3 thus creating an empty space between the first tab 5, the bottom surface 4 of the head section 3, and the second tab 6. The empty space provides sufficient clearance and unobstructed area for the ferrule 11 to be rotatably connected with the handle 1. Furthermore, the first tab 5 and the second tab 6 each comprise a body 7, an annular opening 8, an inner surface 9, and a plurality of tracks 10. In reference to FIG. 3, the annular opening 8 concentrically traverses through the body 7 as the annular opening 8 delineates the inner surface 9. The plurality of tracks 10 is connected onto the inner surface 9 and extends toward a center of the annular opening 8. The plurality of tracks 10 is radially and evenly distributed around the inner surface 9 in order to engage the tension locking mechanism 22 with the first tab 5 and the second tab 6.

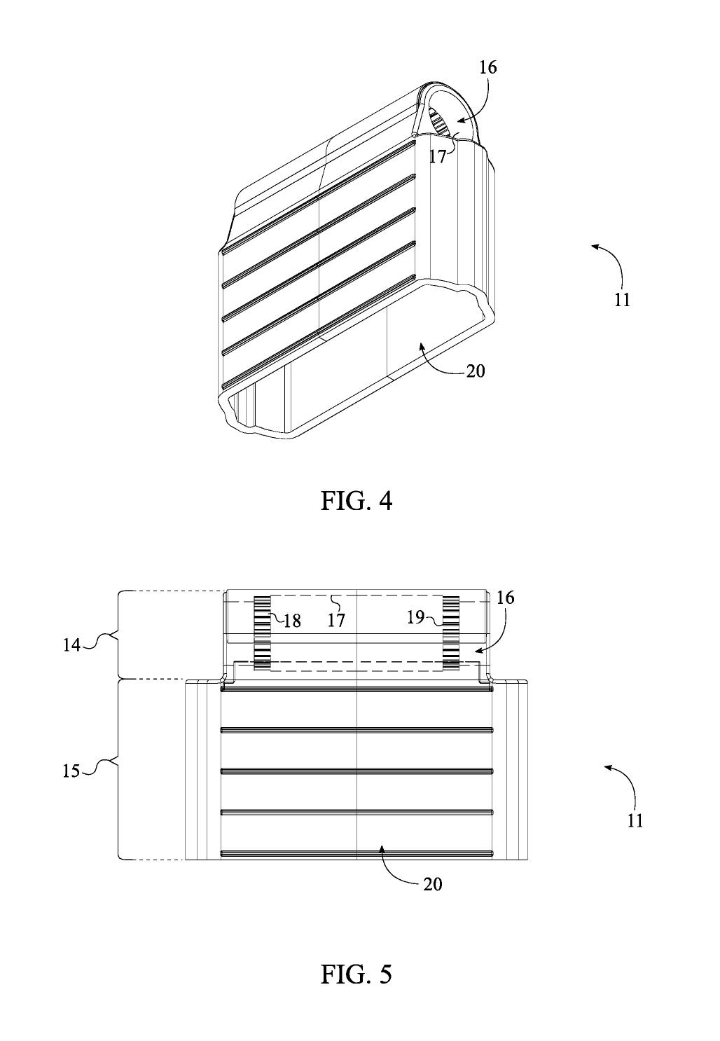

The ferrule 11 functions as the intermediate component between the handle 1 and the plurality of bristles 21. In the preferred embodiment of the present invention, the ferrule 11 comprises a first half 12 and a second half 13 in order to simplify the assembly of the present invention. However, the ferrule 11 of the present invention can be formed into a single body as long as the ferrule 11 is able to rotatably connect with the handle 1 and secure the plurality of bristles 21. In reference to FIG. 4, the sleeve opening 16 traverses through a top end 14 of the ferrule 11 and the bristle opening 20 traverses into a bottom end 15 of the ferrule 11. The sleeve opening 16 is perpendicularly positioned with the bristle opening 20 in order to oppositely position the plurality of bristles 21 and the handle 1. Furthermore, the sleeve opening 16 comprises a lateral surface 17, a first internal gear ring 18, and a second internal gear ring 19 as shown in FIG. 5. The lateral surface 17 is delineated with the sleeve opening 16 and extends through the first half 12 and the second half 13. The first internal gear ring 18 and the second internal gear ring 19 have teeth configured on an inward surface of a gear ring body. The teeth of the first internal gear ring 18 and the second internal gear ring 19 extend toward a center of the sleeve opening 16. As a result, the first internal gear ring 18 and the second internal gear ring 19 are connected to the lateral surface 17 with an outward surface of the gear ring body in a way that the first internal gear ring 18 is adjacently positioned with the first half 12 and the second internal gear ring 19 is adjacently positioned with the second half 13.

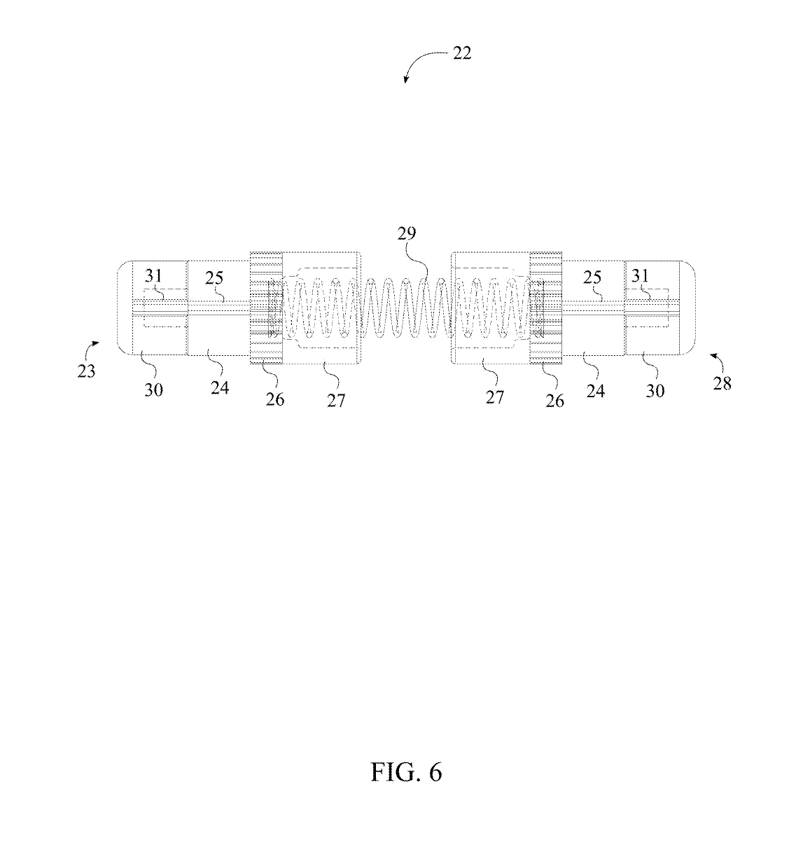

The tension locking mechanism 22 functions as a fastening member between the handle 1 and the ferrule 11. Resultantly, the tension locking mechanism 22 allows the painter to adjust and lock the angle of the ferrule 11 upon the painter's discretion. In reference to FIG. 6, the tension locking mechanism 22 comprises a first cylindrical button 23, a second cylindrical button 28, and a compression spring 29. For the functionality of the tension locking mechanism 22, the compression spring 29 is concentrically positioned in between the first cylindrical button 23 and the second cylindrical button 28. More specifically, the first cylindrical button 23 and the second cylindrical button 28 each comprise an outer knob section 24, a plurality of knob grooves 25, an external gear ring 26, an inner sleeve section 27, a button member 30, and a plurality of button grooves 31. The external gear ring 26 that has teeth configured on an outward surface of a gear ring body is concentrically positioned in between the outer knob section 24 and the inner sleeve section 27. The external gear ring 26 of the first cylindrical button 23 and the second cylindrical button 28 are independently engaged with the ferrule 11 as the compression spring 29 is axially positioned in between the inner sleeve section 27 of the first cylindrical button 23 and the second cylindrical button 28. As a result, the inner sleeve section 27 of the first cylindrical button 23 presses against the compression spring 29 from one end while the inner sleeve section 27 of the second cylindrical button 28 presses against the compression spring 29 from the opposite end. The plurality of knob grooves 25 traverses into the outer knob section 24 in a way that the plurality of knob grooves 25 is radially and evenly distributed around the outer knob section 24. The outer knob section 24 of the first cylindrical button 23 and the second cylindrical button 28 are formed to position within the first tab 5 and the second tab 6 so that the button member 30 of the respective cylindrical button is able to engaged with the outer knob section 24. The button member 30 is concentrically engaged with the outer knob section 24 and positioned opposite of the inner sleeve section 27. The plurality of button grooves 31 traverses into the button member 30 in a way that the plurality of button grooves 31 is radially and evenly distributed around the button member 30. The button member 30 of the first cylindrical button 23 and the second cylindrical button 28 are formed to extend outwardly through the first tab 5 and the second tab 6 so that the painter is able to adjust the angle of the ferrule 11 by pressing the outer knob section 24.

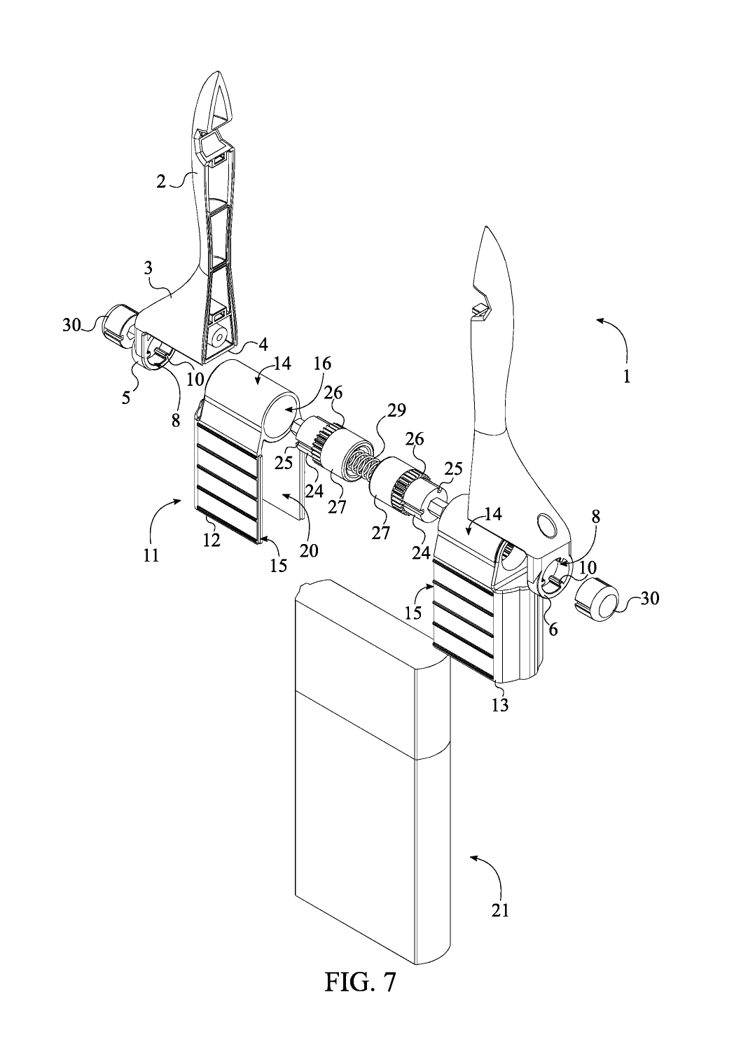

Mechanical configuration of the tension locking mechanism 22 with respect to the handle 1 and the ferrule 11 is shown in FIG. 2 and FIG. 7. More specifically, the first cylindrical button 23 is concentrically positioned with the first tab 5 and the sleeve opening 16. Similarly, the second cylindrical button 28 is concentrically positioned with the second tab 6 and the sleeve opening 16. Resultantly, the compression spring 29 is concentrically positioned within the sleeve opening 16 and in between the inner sleeve section 27 of the first cylindrical button 23 and the second cylindrical button 28. In order to retain the outer knob section 24 of the first cylindrical button 23 and the second cylindrical button 28 within the head section 3, the plurality of knob grooves 25 of the first cylindrical button 23 is engaged with the plurality of tracks 10 of the first tab 5, and the plurality of knob grooves 25 of the second cylindrical button 28 is engaged with the plurality of tracks 10 of the second tab 6. The button member 30 of the first cylindrical button 23 is engaged with the plurality of tracks 10 of the first tab 5 through the plurality of button grooves 31. The button member 30 of the second cylindrical button 28 is engaged with the plurality of tracks 10 of the second tab 6 through the plurality of button grooves 31. In order to lock the ferrule 11 in place with the head section 3 in accordance to the desired angle of the ferrule 11, the first internal gear ring 18 is selectively engaged with the external gear ring 26 of the first cylindrical button 23 while the second internal gear ring 19 is selectively engaged with the external gear ring 26 of the second cylindrical button 28. When the painter presses the button member 30 of the first cylindrical button 23 and the second cylindrical button 28 from each end, the button member 30 and the outer knob section 24 of the first cylindrical button 23 and the second cylindrical button 28 respectively travel along the plurality of tracks 10 of the first tab 5 and the second tab 6. Resultantly, the external gear ring 26 of the first cylindrical button 23 disengaged from the first internal gear ring 18, and the external gear ring 26 of the second cylindrical button 28 disengaged from the second internal gear ring 19. The painter is then able to adjust the angle of the ferrule 11 according the substrate surface. Once the first cylindrical button 23 and the second cylindrical button 28 are released, the compression spring 29 outwardly pushes the first cylindrical button 23 and the second cylindrical button 28 into the initial position thus re-engaging the external gear ring 26 of the first cylindrical button 23 with the first internal gear ring 18 and the external gear ring 26 of the second cylindrical button 28 with the second internal gear ring 19. The ferrule 11 is then locked in place with the handle 1 through the tension locking mechanism 22 while maintaining the desired angle of the ferrule 11.

Although the invention has been explained in relation to its preferred embodiment, it is to be understood that many other possible modifications and variations can be made without departing from the spirit and scope of the invention as hereinafter claimed.

What is claimed is:

1. An adjustable paintbrush comprises:
a handle;
a ferrule;
a plurality of bristles;
a tension locking mechanism;
the plurality of bristles being connected to a bristle opening of the ferrule;
the plurality of bristles being extended from the bristle opening;
a head section of the handle being concentrically positioned with a sleeve opening of the ferrule, opposite of the plurality of the plurality of bristles; and
the head section being rotatably connected with the sleeve opening through the tension locking mechanism.

2. The adjustable paintbrush as claimed in claim 1 comprises:
the handle further comprises a contoured grip section; and
the contoured grip section being adjacently positioned with the head section.

3. The adjustable paintbrush as claimed in claim 1 comprises:
the head section comprises a first tab and a second tab;
the first tab and the second tab being oppositely positioned of a contoured grip section of the handle;
the first tab and the second tab being terminally positioned of each other across a bottom surface of the head section; and
the first tab and the second tab being perpendicularly connected with the bottom surface of the head section.

4. The adjustable paintbrush as claimed in claim 3 comprises:
the first tab and the second tab each comprise a body, an annular opening, an inner surface, and a plurality of tracks;
the annular opening concentrically traversing through the body;
the inner surface being delineated with the annular opening;
the plurality of tracks being connected onto the inner surface; and
the plurality of tracks being radially and evenly distributed around the inner surface.

5. The adjustable paintbrush as claimed in claim 1 comprises:
the sleeve opening traversing through a top end of the ferrule;
the bristle opening traversing into a bottom end of the ferrule; and
the sleeve opening being perpendicularly positioned with the bristle opening.

6. The adjustable paintbrush as claimed in claim 1 comprises:
the sleeve opening comprises a lateral surface, a first internal gear ring, and a second internal gear ring;
the lateral surface being delineated with the sleeve opening;
the first internal gear ring and the second internal gear ring being connected to the lateral surface;
the first internal gear ring being adjacently positioned with a first half of the ferrule; and
the second internal gear ring being adjacently positioned with a second half of the ferrule.

7. The adjustable paintbrush as claimed in claim 1 comprises:
the tension locking mechanism comprises a first cylindrical button, a second cylindrical button, and a compression spring; and
the compression spring being concentrically positioned in between the first cylindrical button and the second cylindrical button.

8. The adjustable paintbrush as claimed in claim 7 comprises:
the first cylindrical button and the second cylindrical button each comprise an outer knob section, a plurality of knob grooves, an external gear ring, an inner sleeve section, a button member, and a plurality of button grooves;
the external gear ring being concentrically positioned in between the outer knob section and the inner sleeve section;
the plurality of knob grooves traversing into the outer knob section;
the plurality of knob grooves being radially and evenly distributed around the outer knob section;
the button member being concentrically engaged with the outer knob section, opposite of the inner sleeve section;
the plurality button grooves traversing into the button member; and
the plurality of button grooves being radially and evenly distributed around the button member.

9. The adjustable paintbrush as claimed in claim 7 comprises:
the compression spring being axially positioned in between an inner sleeve section of the first cylindrical button and an inner sleeve section of the second cylindrical button;
the inner sleeve section of the first cylindrical button being pressed against the compression spring; and
the inner sleeve section of the second cylindrical button being pressed against the compression spring.

10. The adjustable paintbrush as claimed in claim 1 comprises:
a first cylindrical button of the tension locking mechanism being concentrically positioned with a first tab of the head section and the sleeve opening;
a second cylindrical button of the tension locking mechanism being concentrically positioned with a second tab of the head section and the sleeve opening;
a compression spring of the tension locking mechanism being concentrically positioned within the sleeve opening;
a plurality of knob grooves and a plurality of button grooves of the first cylindrical button being axially engaged with a plurality of tracks of the first tab;
a plurality of knob grooves and a plurality of button grooves of the second cylindrical button being axially engaged with a plurality of tracks of the second tab;
a first internal gear ring of the sleeve opening being selectively engaged with an external gear ring of the first cylindrical button; and
a second internal gear ring of the sleeve opening being selectively engaged with an external gear ring of the second cylindrical button.

11. An adjustable paintbrush comprises:
a handle;
a ferrule;
a plurality of bristles;
a tension locking mechanism;
the ferrule comprises a sleeve opening and a bristle opening;
the sleeve opening traversing through a top end of the ferrule;
the bristle opening traversing into a bottom end of the ferrule;
the sleeve opening being perpendicularly positioned with the bristle opening;
the plurality of bristles being connected to the bristle opening;
the plurality of bristles being extended from the bristle opening;
a head section of the handle being concentrically positioned with the sleeve opening, opposite of the plurality of the plurality of bristles; and
the head section being rotatably connected with the sleeve opening through the tension locking mechanism.

12. The adjustable paintbrush as claimed in claim 11 comprises:
the handle further comprises a contoured grip section; and
the contoured grip section being adjacently positioned with the head section.

13. The adjustable paintbrush as claimed in claim 11 comprises:
the head section comprises a first tab and a second tab;
the first tab and the second tab being oppositely positioned of a contoured grip section of the handle;
the first tab and the second tab being terminally positioned of each other across a bottom surface of the head section; and
the first tab and the second tab being perpendicularly connected with the bottom surface of the head section.

14. The adjustable paintbrush as claimed in claim 13 comprises:
the first tab and the second tab each comprise a body, an annular opening, an inner surface, and a plurality of tracks;
the annular opening concentrically traversing through the body;
the inner surface being delineated with the annular opening;
the plurality of tracks being connected onto the inner surface; and
the plurality of tracks being radially and evenly distributed around the inner surface.

15. The adjustable paintbrush as claimed in claim 11 comprises:
the sleeve opening comprises a lateral surface, a first internal gear ring, and a second internal gear ring;
the lateral surface being delineated with the sleeve opening;
the first internal gear ring and the second internal gear ring being connected to the lateral surface;
the first internal gear ring being adjacently positioned with a first half of the ferrule; and
the second internal gear ring being adjacently positioned with a second half of the ferrule.

16. The adjustable paintbrush as claimed in claim 11 comprises:
the tension locking mechanism comprises a first cylindrical button, a second cylindrical button, and a compression spring; and
the compression spring being concentrically positioned in between the first cylindrical button and the second cylindrical button.

17. The adjustable paintbrush as claimed in claim 16 comprises:
the first cylindrical button and the second cylindrical button each comprise an outer knob section, a plurality of knob grooves, an external gear ring, an inner sleeve section, a button member, and a plurality of button grooves;
the external gear ring being concentrically positioned in between the outer knob section and the inner sleeve section;
the plurality of knob grooves traversing into the outer knob section;
the plurality of knob grooves being radially and evenly distributed around the outer knob section;
the button member being concentrically engaged with the outer knob section, opposite of the inner sleeve section;
the plurality button grooves traversing into the button member; and
the plurality of button grooves being radially and evenly distributed around the button member.

18. The adjustable paintbrush as claimed in claim 16 comprises:
the compression spring being axially positioned in between an inner sleeve section of the first cylindrical button and an inner sleeve section of the second cylindrical button;
the inner sleeve section of the first cylindrical button being pressed against the compression spring; and
the inner sleeve section of the second cylindrical button being pressed against the compression spring.

19. The adjustable paintbrush as claimed in claim 11 comprises:
a first cylindrical button of the tension locking mechanism being concentrically positioned with a first tab of the head section and the sleeve opening;
a second cylindrical button of the tension locking mechanism being concentrically positioned with a second tab of the head section and the sleeve opening;
a compression spring of the tension locking mechanism being concentrically positioned within the sleeve opening;
a plurality of knob grooves and a plurality of button grooves of the first cylindrical button being axially engaged with a plurality of tracks of the first tab;
a plurality of knob grooves and a plurality of button grooves of the second cylindrical button being axially engaged with a plurality of tracks of the second tab;
a first internal gear ring of the sleeve opening being selectively engaged with an external gear ring of the first cylindrical button; and
a second internal gear ring of the sleeve opening being selectively engaged with an external gear ring of the second cylindrical button.
